(19) United States
(12) Patent Application Publication
(10) Pub. No.: US 2021/0003095 A1
(43) Pub. Date: Jan. 7, 2021

(54) JET TUBE FOR A TURBOMACHINE

(71) Applicant: Safran Aircraft Engines, Paris (FR)

(72) Inventors: Antonin Etienne Diego Tessiereau, Moissy-Cramayel (FR); Bruno Albert Beutin, Moissy-Cramayel (FR); Benissa Boujida, Moissy-Cramayel (FR); Maxime Christian Darblade, Moissy-Cramayel (FR); Pierre Metge, Moissy-Cramayel (FR)

(21) Appl. No.: 16/917,274

(22) Filed: Jun. 30, 2020

(30) Foreign Application Priority Data
Jul. 4, 2019 (FR) 1907473

(51) Int. Cl. F02K 1/38; B22F 5/10; F01D 25/18; B22F 5/00; B05B 1/26

(52) U.S. Cl. CPC F02K 1/386; B22F 5/10; B33Y 80/00; B22F 5/009; B05B 1/265; F01D 25/18

(57) ABSTRACT

A jet tube for a turbomachine having a tubular main part with an axis and delimiting an internal volume opening out at a first end forming an inlet and at a second end forming an outlet. The jet tube also having a nozzle with a first part radially passing through a wall of the main part. The first part has a first area located radially outside the wall and the internal volume, and a second area located radially inside the wall and the internal volume. The nozzle has a second portion extending axially from the second area of the first portion of the nozzle and towards the outlet. The nozzle has a channel passing through the first and second portions of the nozzle and opening into the internal volume at the free end of the second portion of the nozzle.

### CROSS REFERENCE TO RELATED APPLICATION

This application claims priority to French patent application No. 1907473, filed Jul. 4, 2019, the entirety of which is incorporated by reference herein.

### TECHNICAL FIELD

The present invention concerns a jet tube for a depressurization circuit of a lubrication chamber of a turbomachine, in particular a jet tube which can be produced by an additive manufacturing process.

### BACKGROUND

In a turbomachine, such as a turbojet engine on an aircraft, the bearings are permanently lubricated by lubrication fluid supply systems. Such a system usually includes a reservoir of lubrication fluid and a pump to deliver the fluid to a nozzle located in close proximity to each bearing. The bearings themselves are placed in lubrication chambers closed by dynamic seals. In order to prevent the oiled air in a lubrication chamber from escaping to the outside through the dynamic seals, the pressure inside the lubrication chamber is kept at a certain value which is lower than the outside pressure.

For this purpose, the turbomachine has a lubrication chamber depressurization circuit which connects the internal volume of the lubrication chamber to the secondary flow of the turbomachine. The air pressure in the secondary air stream of the turbomachine is lower than the pressure in the lubrication chamber, which creates a suction phenomenon of the oiled air contained in the lubrication chamber.

The depressurization circuit includes an air de-oiling device that creates pressure drops that reduce the suction phenomenon. To compensate for these pressure losses and to improve the suction phenomenon, it has been proposed to install a jet tube in the depressurization circuit, which locally injects pressurised air into the depressurization circuit, in order to create an additional suction phenomenon.

As can be seen in FIG. 1, a conventional jet tube 1 has a tubular body 2 of axis X, with a first open end 3 forming an air inlet and a second end 4 at which an ejection cone 5 is mounted. Cone 5 is attached to body 2 by means of screws not shown. In addition, jet tube 1 has an injection nozzle 6 mounted laterally on body 2 and opening into the internal volume 7 of body 2. The injection nozzle 6 is connected to a plate 8, which is screwed to the body 2.

Nozzle 6 comprises a radially extending part 6a, relative to the X-axis of the body, and an axially extending part 6b, connected to each other by a bent part 6b. The free end 6d of nozzle 6 has a frustoconical shape.

Oil laden air is introduced into nozzle 6 and compressed air is introduced through inlet 3 of body 2. Compressed air is taken from the compressor of the turbomachine.

The flow of compressed air causes the oil-laden air to be sucked in, which opens out at the frustoconical part 6d into the internal volume 7 of the housing 2 in the manner of a venturi. There is currently a need to reduce the mass, cost and complexity of such a jet tube. The invention aims at proposing the realization of such a jet tube in a one-piece way, by means of an additive manufacturing process, such as for example by selective fusion or selective sintering of powder.

It should be remembered that such a process consists of aggregating, by selective fusion in an enclosure under neutral gas, the particles of a bed of powder by means of a laser or electron beam which scans the surface and melts the powder over a determined section so as to form a layer of the part after solidification. The construction platform, on which the first layer of the workpiece is attached, is then lowered so that a new layer of powder of predetermined thickness can be applied. The laser or electron beam then scans the powder surface again to create an additional layer on top of the previous layer. The part is thus entirely made by stacking successive layers.

Such a method is for example known from document FR 3 030 323, in the name of the Applicant.

However, the realisation of the jet tube according to the present structure requires the installation of numerous edification supports between certain areas of the room, in particular cantilevered areas, and the tray, or between two areas of the room.

Such supports must be removed by machining, which generates additional costs and risks of damage to the workpiece during machining.

The invention aims at adapting the structure of the jet tube so as to avoid or limit the number of edification supports necessary for its realization.

### SUMMARY

For this purpose, the invention concerns a jet tube for a turbomachine comprising a tubular main part having an axis and delimiting an internal volume opening out at a first end forming an inlet and at a second end forming an outlet, a nozzle comprising a first part radially passing through a wall of the main part, said first part comprising a first area located radially outside said wall and said internal volume, and a second area located radially inside said wall and said internal volume, the nozzle having a second portion extending axially from the second area of the first portion of the nozzle and towards said outlet, said nozzle having a channel passing through said first and second portions of the nozzle and opening into said internal volume at the free end of the second portion of the nozzle, characterized in that the main part and the nozzle are made in one piece, the second area has a surface facing said inlet and whose line of intersection with the radial median plane of the second area forms, for example at any point of said line of intersection, an angle α≤45°, preferably between 44° and 45° with the X-axis.

Such a structure makes it possible to create the second area of the first part of the nozzle without the use of a support specific to this area.

The second area may comprise a protrusion located between the channel and the inlet and attached to the wall of the main part, said protrusion defining, at least in part, said surface facing the inlet.

Such a feature allows the general orientation and position of the nozzle to be maintained, while facilitating the production of the jet tube by additive manufacture thanks to the presence of the protrusion which limits the overhang effect that is detrimental to such manufacture. This avoids the need to use edification supports.

The protrusion may have a first tapered end facing the inlet and a second end connected continuously to the rest of the second area.

The continuous connection is a connection providing surface continuity between the protrusion and the rest of the second area.

The protrusion may have the general shape of a water drop with the tapered part facing the inlet.

The first part of the nozzle may extend along an axis forming an angle α≤45°, preferably between 44° and 45° with the axis of the main part.

The first part of the nozzle may extend along an axis perpendicular to the axis of the main part.

The first part of the nozzle can be cylindrical.

The first area may comprise a protrusion located between the channel and the inlet and attached to the wall of the main part, said protrusion defining, at least in part, a surface facing the inlet and whose line of intersection with the median radial plane of the second area forms, for example at any point of said line of intersection, an angle α≤45°, preferably between 44° and 45° with the axis of the main part.

The protrusion of the first area may have a first tapered end facing the inlet and a second end connected continuously to the rest of the second area.

The second part of the nozzle may comprise a downstream part having at least two injection areas which are separate from one another and each open into the internal volume of the main part in the direction of the outlet, the injection areas being connected to a common upstream part.

The term upstream is defined in relation to the direction of gas flow through the nozzle.

For example, the number of separate injection areas is three.

The use of several injection areas further improves the efficiency of the venturi, i.e. increases the flow rate of oil-laden air that is sucked in by the compressed air flow.

The inlet and/or outlet may have tapered sections flaring towards the opposite outlet or the opposite inlet respectively.

Said main part may comprise an annular wall comprising, from the first end towards the second end, a cylindrical neck, a truncated conical portion flaring towards the outlet, a cylindrical portion, a truncated conical portion flaring towards the inlet and a neck. Each neck may have a shoulder and/or radial flange for connection to an external element.

At least one tongue or at least one attachment clevis may extend radially outwards from the main part, e.g. from the cylindrical part.

The tongue or attachment clevis allows the jet tube to be fixed to a fixed part of the turbomachine.

The invention also relates to a turbomachine comprising a jet tube of the above-mentioned type. The turbomachine may be a turbojet engine or turboprop engine.

The turbojet engine may be a bypass turbojet engine and comprise a primary flow path and a secondary flow path, the turbojet engine comprising a casing externally surrounding or delimiting the secondary flow path, the jet tube being fixed to said casing.

The invention also relates to a process for manufacturing a jet tube of the aforementioned type, characterised in that said jet tube is produced layer by layer, by selective fusion or selective sintering of powder, the axis of stacking of the layers corresponding overall to the axis of the main part, said layers being produced successively from the inlet to the outlet of the main part. The geometry is realised without the need for support due to the use of suitable construction angles (≥45° to the production table and therefore 545° to the X-axis).

### BRIEF DESCRIPTION OF THE FIGURES

FIG. 1 is a cross-sectional axial and perspective view of a jet tube according to the prior art,

FIG. 2 is a cross-sectional axial view of a jet tube according to a first embodiment of the invention,

FIG. 3 is a perspective and partial sectional view of a part of the jet tube of FIG. 2,

FIG. 4 is a perspective view of a part of the jet tube of FIG. 2,

FIG. 5 is a perspective and partial sectional view of a jet tube according to a second embodiment of the invention.

### DETAILED DESCRIPTION

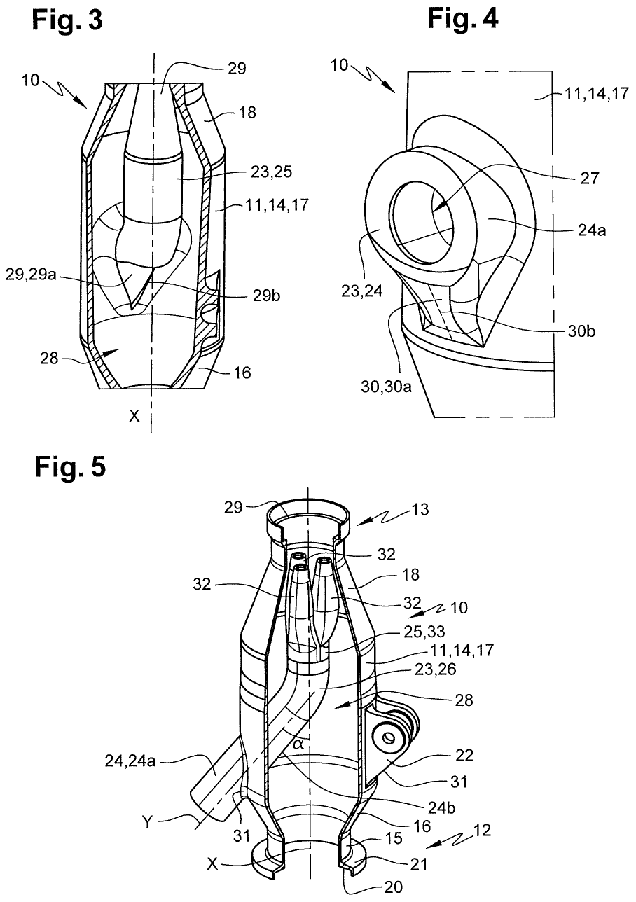

FIGS. 2 to 4 illustrate a jet tube 10 according to a first embodiment of the invention. For example, the jet tube 10 is intended to equip a depressurization circuit with a lubrication chamber of a turbomachine, in particular a double flow jet engine.

The jet tube 10 has a one-piece body comprising a main tubular central part 11, of X axis. Said main part 11 has a first end 12 forming an inlet and a second end 13 forming an outlet. Said main part 11 comprises an annular wall 14 comprising, from the first end 12 towards the second end 13, a cylindrical neck 15, a truncated conical portion 16 flaring towards the outlet 13, a cylindrical portion 17, a truncated conical portion 18 flaring towards the inlet 12 and a neck 19. Each neck 15, 19 may have a shoulder 20 and/or radial flange 21 intended to be connected to an external element.

The terms axial, radial and circumferential are defined relative to the X axis.

At least one tongue or at least one attachment clevis 22 may extend radially outwards from the main part 11, e.g. from the cylindrical part 17.

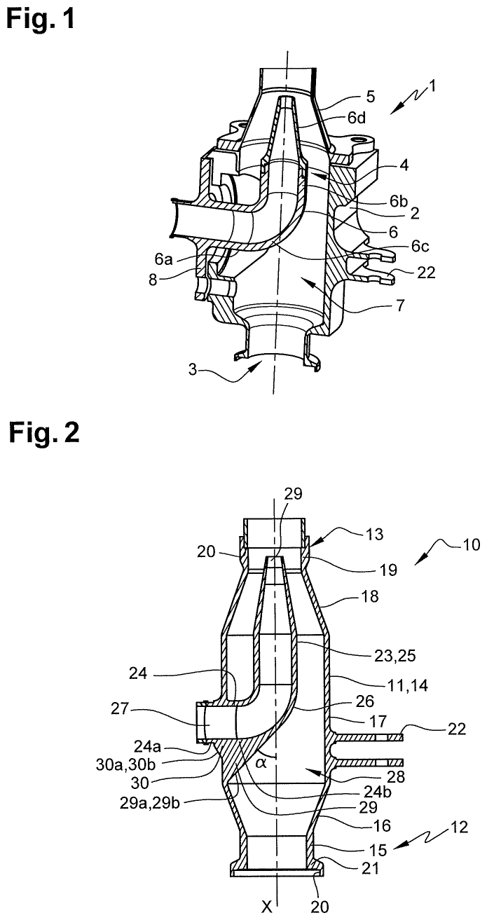

The jet tube 10 further comprises a nozzle 23 comprising a first part 24 extending radially and a second part 25 extending axially from the first part, connected to each other by a bent part 26. In the embodiment of FIGS. 1 to 4, the axis of the first part 24 is perpendicular to the axis of the second part 25. Furthermore, the axis of the second part 25 coincides with the X axis of the main part 11.

The main part 11 and nozzle 23 are made in a single piece, i.e. in one piece, by an additive manufacturing process, e.g. selective melting or selective powder sintering.

Nozzle 23 has a channel 27 passing through said first and second parts 24, 25 of nozzle 23 and opening into the internal volume 28 of the main part 11 at the free end 32 of the second part of nozzle 23.

The first part 24 passes radially through wall 14 of the main part 11, said first part 24 having a first area 24a located radially outside said wall 14 and said internal volume 28 and a second area 24b located radially inside said wall 14 and said internal volume 28.

The second area 24b comprises a protrusion 29 located between channel 27 and inlet 12 and attached to wall 14 of the main part 11, said protrusion 29 being housed in the internal volume 28 of the main part 11.

The protrusion 29 has a first tapered end facing the inlet 12 and a second end connected continuously to the rest of the second area 24b. The protrusion 29 may have the general shape of a water drop with the tapered part facing the inlet 12.

Said protrusion 29 defines a surface 29a facing inlet 12. The surface is generally tilted with respect to the radial direction and with respect to the axial direction. In particular, the line of intersection of this surface with the median radial plane of the second area 24b forms at any point an angle α≤45°, preferably between 44° and 45° with the X axis.

The first area 24a comprises a protrusion located between channel 27 and inlet 12 and attached to wall 14 of the main part 11, said protrusion being housed in the internal volume 28 of the main part 11. The protrusion defines a surface which faces the inlet 12 and whose line of intersection 29b with the radial median plane of the second area 24b (which is the axial sectional plane of FIG. 2) forms at any point an angle α≤45°, preferably between 44° and 45° with the X-axis of the main part 11.

The first area 24a also comprises a protrusion 30 having a first tapered end facing the inlet 12 and a second end connected continuously to the rest of the second area 24b. This protrusion 30 may have the general shape of a water drop with the tapered part facing the inlet 12. As previously, said protrusion 30 defines a surface 30a facing inlet 12. The surface 30a is generally tilted with respect to the radial direction and with respect to the axial direction. In particular, the line of intersection 30b of this surface 30a with the median radial plane of the first area 24a (axial sectional plan of FIG. 2) forms at any point an angle α≤45°, preferably between 44° and 45° with the X axis.

The free end 32 of the second part 25 has a frustoconical shape tapering towards outlet 13. The presence of the protrusions 29, 30 makes it easier to make the jet tube 10 by additive manufacture, limiting the overhang effect in the first and second areas 24, 25 and therefore the need to provide edification supports in these areas 24, 25.

In operation, oil laden air is introduced into nozzle 23 and compressed air is introduced in the internal volume 28 through inlet 12. Compressed air is taken from the compressor of the turbomachine.

The flow of compressed air causes the oil-laden air to be sucked in, which opens out at the frustoconical part 32 into the internal volume 28 in the manner of a venturi.

FIG. 5 shows a jet tube 10 in a second embodiment of the invention, which differs from that shown in reference to FIGS. 1 to 4 in that the first part 24 is cylindrical and without protrusions similar to those shown above, and is tilted along a Y axis forming an angle with the radial plane and with the X axis. The angle α between the Y-axis of the first part 24 and the X-axis is ≤45°, preferably between 44° and 45°.

Between wall 14 of the main part 11 and the first part 24, fillet radii 31 can be provided. These fillet radii 31 have small connection radii, e.g. less than 2 mm. These fillet radii 31 are not assimilated to protrusions similar to those described above. Of course, such protrusions could be provided for, in addition to the particular inclination of the first part 24 with respect to the X axis and the radial plane.

Such a structure also makes it possible, because of such an inclination, to avoid the use of edification supports for the realization of the first part 24 during additive manufacturing.

In addition, each attachment tongue 22 may have a inclined edge 31 facing the inlet. The inclined edge 33 forms, for example at any point on said edge 33, an angle α with the X-axis which is ≤45°, preferably between 44° and 45°.

In this embodiment, attachment tongue 22 extends along the X-axis in order to facilitate construction using an additive manufacturing process without the need for support for the above-mentioned reasons.

In this second embodiment, the free end of the nozzle 23 opening into the internal volume 28 of the first part 24 has three distinct injection areas 32, evenly distributed angularly around the X axis. The different injection areas 32 are connected to the same common upstream area 34 of the second part 25, the term upstream being used with reference to the direction of flow within nozzle 23. Each injection area 32 has a general frustoconical shape tapering towards outlet 13. The use of several injection areas 32 further improves the efficiency of the venturi, i.e. increases the flow rate of oil-laden air that is sucked in by the compressed air flow in the internal volume 28, from inlet 12 to outlet 13.

1. A jet tube for a turbomachine, the jet tube comprising a tubular main part having an axis and delimiting an internal volume opening out at a first end forming an inlet and at a second end forming an outlet, a nozzle comprising a first part radially passing through a wall of the main part, said first part comprising a first area located radially outside said wall and said internal volume, and a second area located radially inside said wall and said internal volume, the nozzle having a second portion extending axially from the second area of the first portion of the nozzle and towards said outlet, said nozzle having a channel passing through said first and second portions of the nozzle and opening into said internal volume at the free end of the second portion of the nozzle, wherein the main part and the nozzle are made in one piece, the second area has a surface facing said inlet and whose line of intersection with the radial median plane of the second area forms an angle α between 44° and 45° with the axis, the second area comprising a protrusion located between the channel and the inlet and attached to the wall of the main part, said protrusion defining, at least in part, said surface facing the inlet.

2. The jet tube according to claim 1, wherein the protrusion has a first tapered end facing the inlet and a second end connected continuously to the rest of the second area.

3. The jet tube according to claim 1, wherein the first part of the nozzle extends along an axis forming an angle of between 44° and 45° with axis X of the main part.

4. The jet tube according to claim 1, wherein the first part of the nozzle extends along an axis perpendicular to axis of the main part.

5. The jet tube according to claim 1, wherein the first part of the nozzle is cylindrical.

6. The jet tube according to claim 1, wherein the first area comprises a protrusion located between the channel and the inlet and attached to the wall of the main part, said protrusion defining, at least in part, a surface which faces the inlet and whose line of intersection with the radial median plane of the second area forms an angle of between 44° and 45° with the axis of the main part.

7. The jet tube according to claim 1, wherein the second part of the nozzle comprises a downstream part having at least two injection areas which are separate from one another and each open into the internal volume of the main part in the direction of the outlet, the injection areas being connected to a common upstream part.

8. A turbomachine comprising the jet tube according to claim 1.

9. A method of manufacturing the jet tube according to claim 1, wherein said jet tube is made layer by layer, by selective melting or selective sintering of powder, the axis of stacking of the layers generally corresponding to the axis of the main part, said layers being made successively from the inlet to the outlet of the main part without the need for support.
